(19) United States
(12) Patent Application Publication
(10) Pub. No.: US 2026/0157393 A1
(43) Pub. Date: Jun. 11, 2026

(54) FOOD ANALOGUES PREPARATION METHOD AND PRODUCTS

(71) Applicant: Redefine Meat Ltd., Rehovot (IL)

(72) Inventors: Alexey TOMSOV, Giv'atayim (IL); Daniel MANDELIK, Rehovot (IL); Sagee SCHACHTER, Tel Aviv (IL); Stella ITZHAKOV, Gan Yavne (IL); Daniel DIKOVSKY, Ariel (IL)

(21) Appl. No.: 18/708,003

(22) PCT Filed: Nov. 14, 2022
(86) PCT No.: PCT/IL2022/051214

§ 371 Date: May 7, 2024

(30) Foreign Application Priority Data
Nov. 14, 2021 (IL) 288107

(51) Int. Cl. A23J 3/22; A23J 3/14; A23J 3/16; A23J 3/18; A23J 3/26

(52) U.S. Cl. CPC A23J 3/227; A23J 3/14; A23J 3/16; A23J 3/18; A23J 3/26

(57) ABSTRACT

The present disclosure provides method for producing alternative food product and an alternative food product, preferably alternative whole muscle cut meat product; and such food product. The method involves (a) providing a plurality of elongate texturized vegetable protein (TVP) strands; (b) forming a first monolayer of essentially parallelly aligned elongate TVP strands; and (c) forming at least one additional monolayer of essentially parallelly aligned elongate TVP strands, each additional monolayer formed over a previously formed monolayer; wherein a rehydrated sample of TVP extrudate from which said plurality of TVP strands are formed, has a crossover modulus of at least 2.5 KPa as determined, at 25° C., in an Amplitude Sweep mode, from 3·10⁻²% to 3·10³%, at a constant frequency of 10 rad/s and a constant axial force of 25 N.

### TECHNOLOGICAL FIELD

The present disclosure relates to the food industry, particularly to the Alt-meat industry.

### BACKGROUND ART

References considered to be relevant as background to the presently disclosed subject matter are listed below:
International Patent Application Publication No. WO 2020/152689
International Patent Application Publication No. WO2021/095034
International Patent Application Publication No. WO2021/191906

Acknowledgement of the above references herein is not to be inferred as meaning that these are in any way relevant to the patentability of the presently disclosed subject matter.

### BACKGROUND

There is a major interest in meat analogues (also referred herein as alt-meat or alternative meat) due to environmental and moral factors. More and more people switch their consumption preferences without really abandoning the love to the taste of real meat. The range of desired alternative products go from minced meat and chicken nuggets, to include whole muscle cuts.

One of the elements that are difficult for reconstruction in the Alt-meat industry is the fibrillar nature of meat. In livestock meat, muscle fibers together with their connective tissue envelope form a highly anisotropic and strong structure that is responsible for the chewy nature of the whole muscle meat.

WO 2020/152689, WO2021/095034 and WO2021/191906 each independently describe, inter alia, the use of TVP in the fabrication of meat analogues by additive manufacturing techniques.

### GENERAL DESCRIPTION

The present disclosure is based on the development of alternative meat products and particularly whole muscle cut products (referred to herein at times, by the term as “alt-meat” or “meat analogue”) from strands from texturized vegetable protein (TVP) extrudates as opposed to alt meat products that are produced from TVP containing dough material.

In fact, it has been found that dry TVP extrudate can be used as is, i.e. sliced into elongate strands, re-hydrated and then constructed into a multilayer product, without forming it into a dough.

Thus, in accordance with a first aspect of the presently disclosed subject matter there is provided a method for producing an alternative food product, preferably an alternative whole muscle cut product, the method comprises
providing a plurality of elongate texturized vegetable protein (TVP) strands;
forming a first monolayer of essentially parallelly aligned elongate TVP strands;
forming at least one additional monolayer of essentially parallelly aligned elongate TVP strands, each additional monolayer formed over a previously formed monolayer;
wherein a rehydrated sample of the TVP from which said elongate TVP strands are formed has a modulus at a cross-over point (crossover modulus point) of at least 2.5 KPa as determined, at 25° C., in an Amplitude Sweep mode, from 3·10-2% to 3·10³%, at a constant frequency of 10 rad/s and a constant axial force of 25 N.

In accordance with a second aspect of the presently disclosed subject matter there is provided an alternative food product, preferably, an alternative whole muscle cut meat product, comprising a plurality of stacked TVP containing monolayers, each monolayer comprising elongate strands aligned in a common nominal direction one with respect to another in said monolayer, and preferably in said product;
wherein upon shearing said alternative meat product, for about 30 seconds, using a dough blade, the alternative meat product disintegrates and provides discrete elongate TVP strands having a longitudinal dimension and a thickness dimension, the longitudinal dimension being greater than the thickness dimension; and
wherein said product has a nominal dimension in said nominal direction, and the longitudinal dimension of a majority of the discrete elongate TVP strands is generally same as said nominal dimension.

Further provided in accordance with the second aspect of the presently disclosed subject matter an alternative food product, preferably, an alternative whole muscle cut meat product, comprising a plurality of stacked TVP containing monolayers, each monolayer comprising elongate strands aligned in a common nominal direction one with respect to another in said monolayer, and preferably in said product;
wherein said product has a nominal dimension in said nominal direction, and the longitudinal dimension of a majority of the discrete elongate TVP strands is generally same as said nominal dimension; and
wherein a load of at least 10N or 25N is required for, respectively 66% or 80% penetration of a 1 mm thick metal plate jig progressed into said food product in a velocity of 50 mm/min, the metal jig being in an orientation that is perpendicular to a nominal direction of elongate strands within the product.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are schematic illustrations side by side with a corresponding block diagram of a method for obtaining meat analogues according to some examples of the present disclosure (FIG. 1A), and a method for providing TVP strands (FIG. 1B) to be used in a method for obtaining meat analogues according to some examples of the present disclosure.

FIGS. 2A-2C provide an image of a modified bite test, showing specifically, a 1 mm thick metal plate jig and a metal platform of commercial TPA, having a test sample thereon (FIG. 2A) and the direction of operating a cut in a test sample, in the direction of the strands (FIG. 2B) or in a direction perpendicular to the direction of the strands (FIG. 2C).

FIG. 3 is a graph showing the load vs. sample penetration for a sample obtained from Chopped TVP Strands or from Whole TVP Strands (KWN #1) according to the modified bite test described herein.

FIG. 4 is a schematic illustration of a 3-point bending test performed in accordance with the present disclosure

FIGS. 5A-5C are images of the type of failure obtained upon performing the 3-point bending test according to the present disclosure, on samples from Whole TVP Strands, and Chopped TVP Strands samples when the bend is in direction perpendicular to the direction of the strands in the sample (FIG. 5A) or perpendicular to the direction of the strands (FIG. 5B); and the type of failure in the sample from Whole Strands vs. sample of livestock beef tenderloin (FIG. 5C).

FIGS. 6A-6C are top view images of the morphology of the fracture of meat reference Sirloin (FIG. 6A), Tenderloin (FIG. 6B) and Whole TVP Strand sample (FIG. 6C). The scale in each Figure being 2 mm.

FIG. 7 is a graph showing the change in the tested height (i.e. elasticity) of whole, rehydrated, TVP extrudates (KWN #1, KWN #2, KWN #3 and KWN #4), after a first compression in a compression test, the TVP extrudates comprising essentially the same chemical composition.

FIGS. 8A-8F are graphs showing the different tested samples' (KWN #1, KWN #2, KWN #3, KWN #4, KWN #6 and QTQ) storage modulus (G′) and loss modulus (G″) as a function of oscillation strain.

FIG. 9 is a graph presenting the modulus at the cross-over point (crossover modulus), of different TVP samples

FIGS. 10A-10B are optical microscope images of two re-hydrated Whole TVP Strands (KWN #4 and KWN #2), respectively, where the cross-section was exposed by cutting the samples perpendicular to the TVP extrudate direction (elongate pores' direction), showing the difference in density of the TVP extrudates, with KWN #4 being denser.

FIGS. 11A-11E are images of disintegrated alternative meat samples prepared from an alternative steak having a thickness of 2.0 cm and comprising Whole TVP Strands (FIGS. 11A-11B); the steak being cut from a slab of an alternative whole muscle cut in a direction perpendicular to the direction of the elongate TVP strands; from an alternative whole muscle cut meat product comprising Whole TVP Strands (FIG. 11C) or from a Chopped TVP Strands steak (FIG. 11D-11E).

FIGS. 12A-12B are microscope images of a cross sectional cut from an alternative whole muscle cut product obtained from Whole TVP Strands (FIG. 12A), according to the present disclosure or from Chopped Strands (FIG. 12B), the former showing pores in the protein mass.

### DETAILED DESCRIPTION

The presently disclosed subject matter provides, in accordance with a first of its aspects, a method for producing alternative food product, the method comprises:
providing a plurality of elongate texturized vegetable protein (TVP) strands;
forming a first monolayer of essentially parallelly aligned elongate TVP strands;
forming at least one additional monolayer of essentially parallelly aligned elongate TVP strands, each additional monolayer formed over a previously formed monolayer;
wherein a rehydrated sample of the TVP from which said elongate TVP strands are formed, has a crossover modulus (modulus at a cross-over point) of at least 2.5 KPa as determined, at 25° C., in an Amplitude Sweep mode, from 3·10⁻²% to 3·10³%, at a constant frequency of 10 rad/s and a constant axial force of 25 N.

In some preferred examples of the presently disclosed subject matter, the alternative food product is an alternative whole muscle cut product.

In the context of the present disclosure when referring to alternative whole muscle cut product it is to be understood to encompass any meat product that has not been processed by chopping or mincing or grinding. This includes, without being limited thereto, slabs and cuts of slabs such as steaks, meat chunks and meat cubes.

The alternative food product contains, as one of its component's, proteins. The protein, in accordance with the presently disclosed subject matter is or comprises texturized vegetable protein (TVP).

In the context of the present disclosure, it is to be understood that “texturized vegetable protein” or “TVP” has the meaning as known in the art. TVP is known in the art to be used as a meat extender or vegetarian meat and is usually created by extruding protein isolates, concentrates or flour and/or their mixtures with water and/or additives such as corn-starch or other edible compounds, using high shear, pressure and heat, from vegetable sources such as wheat, pea and others. Thus, in the context of the present disclosure, when referring to TVP, it is to be understood to refer to the product of extrusion, or in other words, the extrudate.

TVP extrudates are commercially available in different sizes from sheet like structures and large chunks to small flakes. In the context of the present disclosure, the TVP is obtained or obtainable from the sheets, stripes or large chunks, from which the desired elongate strands are sliced or otherwise processed into the elongate TVP strands, without changing intrinsic textural properties of the TVP that results from the actual extrusion process (e.g. without chopping the TVP).

In the context of the present disclosure, when referring to elongate TVP strands it is to be understood to mean TVP having at least one dimension that is at least twice greater than any other dimension of the strand. The greater dimension is referred to herein as the longitudinal dimension (correlating with the strand's longitudinal direction). The other dimensions can be referred to as the width, height, thickness, cross sectional diameter.

Some examples of the presently disclosed subject matter are based on the realization that texturized vegetable protein (TVP) extrudates, sliced into elongate strands having a longitudinal dimension of at least 2 cm and at least one (shorter) dimension (e.g. dimension perpendicular to the longitudinal dimension) of between 0.2 mm and about 10 mm, at times of between 0.2 mm and about 6 mm are advantageous for the production of alternative whole muscle cut product, in additive manufacturing techniques. For the formation of the alternative whole muscle cut product, the elongate TVP extrudate strands are disposed layer-wise one on top of the other, with the strands being essentially or generally in the same orientation. In some examples, the strands are, or the monolayer of strands, are substantially covered, at least partially, with a food grade binding composition.

There are different TVP extrudates that can be used in the presently disclosed method or as part of the presently disclosed whole alt-meat product.

Based on the inventors' realization, it is now provided, in accordance with a first aspect of the presently disclosed subject matter, a method for producing an alternative food product comprising layers of TVP. The method is based on additive manufacturing techniques, making use of whole TVP strands instead of strands made from chopped TVP.

Thus, in the context of the presently disclosed subject matter, when referring to Whole TVP Strands or in short Whole Strands, it is to be understood to denote strands or strips directly cut out of a TVP extrudate.

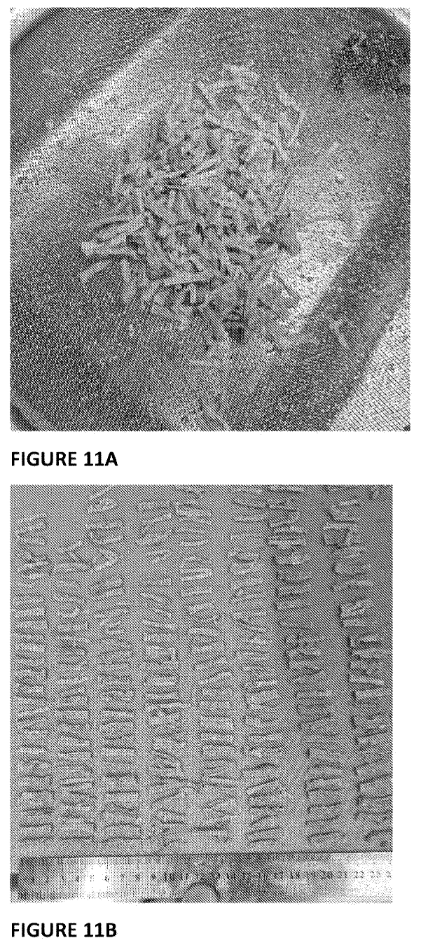

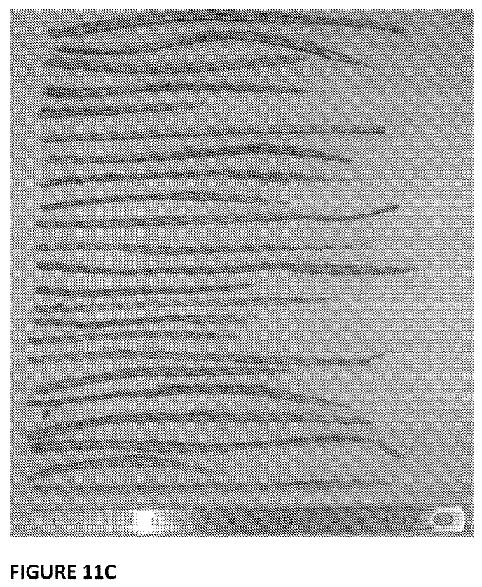

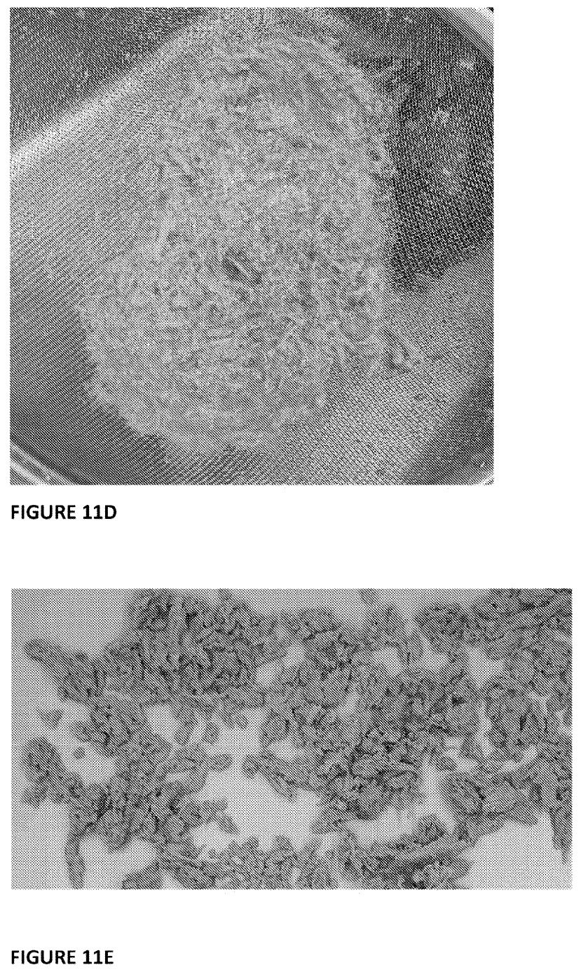

An alternative whole muscle cut product made with Whole TVP Strands is identifiable or distinguished from Chopped TVP Strands product by the strands' integrity after the product is subjected to even gentle shear forces. Specifically, when a product from Whole TVP strands is subjected to such shear forces, the strands essentially maintain their elongated, strand structure, while a product from chopped TVP disintegrated into irregular amorphous structures, as shown for example in FIG. 11E.

The Whole TVP Strands employed by the present invention can also be identified or distinguished from other TVP strands by TVP's modulus at a cross-over point (crossover modulus) as determined on a rehydrated sample of the TVP extrudate from which the strands are formed. Specifically, the rehydrated TVP extrudate from which the strands are formed, according to the presently disclosed subject matter, has a crossover modulus of at least 2.5 KPa as determined, at 25° C., in an Amplitude Sweep mode, from 3·10⁻²% to 3·10³%, at a constant frequency of 10 rad/s and a constant axial force of 25 N. It is to be noted that the cross over modulus is to be determined in TVP that is rehydrated with water.

For the purpose of determining modulus at a cross-over point of a TVP extrudate, the TVP extrudate is rehydrated at a weight ratio of 1:2.1. for this purpose, rehydration is achieved by soaking with the water.

In some examples of the presently disclosed subject matter, the Whole TVP Strands employed by the present are obtained from a TVP extrudate, which when rehydrated as defined herein, have a crossover modulus, determined as described above, of between about 2.5 KPa and KPa; at times, between about 3 KPa and 20 KPa; at times, between about 5 KPa and 15 KPa; at times, between about 3 KPa and 15 KPa; at times, between about 2.5 KPa and 10 KPa; at times, between about 3 KPa and 12 KPa; at times, between about 5 KPa and 20 KPa; at times, between about 2.5 KPa and 12 KPa; or any range between 2.5 KPa and 25 KPa, even if the range is not literally and/or explicitly recited herein.

Further, in the context of the presently disclosed subject matter, when referring to Chopped TVP Strands or, in short, Chopped Strands, it is to be understood to denote strands or strips obtained by extrusion of TVP dough, the latter obtained from chopped TVP extrudate.

The herein disclosed method thus comprises
providing a plurality of elongate texturized vegetable protein (TVP) strands;
forming a first monolayer of essentially parallelly aligned elongate TVP strands;
forming at least one additional monolayer of essentially parallelly aligned elongate TVP strands, each additional monolayer formed over a previously formed monolayer;
wherein a sample of rehydrated TVP from which said plurality of TVP strands are formed, has a crossover modulus of at least 2.5 KPa as determined, at 25° C., in an Amplitude Sweep mode from 3·10⁻²% to 3·10³%, at a constant frequency of 10 rad/s and a constant axial force of 25 N.

In some examples, the TVP strands are hydrated prior to the formation of a monolayer. Rehydration can be done by soaking the TVP (before or after it is cut into strands, but preferably, before strands formation) with liquid, the liquid being any one of water, an aqueous based solution, e.g. a marinade; and emulsion (oil in water).

In some examples of the presently disclosed subject matter, rehydration is at a weight ratio between the TVP extrudate and the liquid of between about 1:1.5 and about 1:5.

In some examples of the presently disclosed subject matter, rehydration is at a weight ratio between the TVP extrudate and the liquid of between about 1:1.8 and about 1:4; at times, between about 1:2 and 1:4; at times, between about 1:2 and 1:3.

In some examples of the presently disclosed subject matter, rehydration is in an amount of liquid selected to reach an increase in weight of the final product of between about 200 wt % and 350 wt % with respect to the weight of the dry matter before rehydration.

The rehydration as described above, provides a rehydrated TVP with between 30 wt % and 90 wt % water out of the total weight of the rehydrated product, at times, between about 30 wt % and 70 wt % water out of the total weight of the rehydrated product, or between 50 wt % and 80 wt % water out of the total weight of the rehydrated product or preferably between 60 wt % and 80 wt % water out of the total weight of the rehydrated product.

In some examples, the Whole TVP Strands of the presently disclosed subject matter are characterized by the presence of pores within the protein mass (i.e. the TVP mass). In some examples, the Whole TVP Strands contain at least some elongate pores.

Without being limited thereto, it is believed that the presence of pores in the protein mass contributes to the organoleptic properties of the resulting product, e.g. in its chewiness.

In some examples, the strands are cut such that the longitudinal direction of the strand is generally parallel with the longitudinal direction of the elongate pores.

In the context of the presently disclosed subject matter, when referring to elongate pores it is to be understood to mean open cell structures within the protein's mass that have at least one dimension that is at least twice greater than any other dimension of the pore. The greater dimension is referred to herein as the longitudinal dimension (correlating with the pore's longitudinal direction). The other dimensions can be referred to as the width, height, thickness, cross sectional diameter of the pores.

In the context of the presently disclosed subject matter, when referring to pores within the protein (TVP) mass it is to be understood that the TVP mass may include also pores (open cell structures) that are not elongate, under the herein disclosed definition. Yet, the protein mass includes at least one visible elongate pore.

Without being bound by theory, it is believed that the elongate pores, if present in the Whole TVP strands, are formed during extrusion of the protein mass during formation of the TVP extrudate. As such, the majority, if not essentially all, of the elongate pores within a TVP extrudate share a common nominal direction that correlates with the direction of extrusion.

Thus, it is to be understood that when identifying the longitudinal direction of elongate pores within Whole TVP strands, it, in fact, can signify the direction of the TVP extrusion and/or direction of the fibrous material within the TVP extrudate.

In some examples of the presently disclosed subject matter, when the Whole TVP Strands or the product obtained from Whole TVP Strands comprises pores within the protein mass of the product, the pores have at least one dimension that is at least 0.1 mm. In some examples, the pores have at least one dimension that is at least 0.2 mm; at times, at least 0.3 mm; at times, at least 0.4 mm; at times, at least 0.5 mm.

In some examples of the presently disclosed subject matter, the Whole TVP Strands are formed by slicing a rehydrated TVP extrudate in a direction that is generally in parallel with the longitudinal direction of elongate pores/direction of extrusion.

In some examples of the presently disclosed subject matter, the rehydrated TVP extrudate is separated into elongate strands along the direction of extrusion. The rehydrated TVP, is strong and resilient in a direction perpendicular to the direction of extrusion which is also the direction of slicing into the Whole TVP Strands.

As noted above, the Whole TVP Strands have also a thickness dimension. It is to be understood, in the context of the presently disclosed subject matter that the thickness dimension is measured in a direction perpendicular to the direction of extrusion of said TVP extrudate and/or perpendicular to the longitudinal dimension of the elongate pores.

In some examples of the presently disclosed subject matter, the longitudinal dimension in a majority of the elongate strands is at least twice greater than the thickness dimension. In this context, when referring to a majority of the elongate strands, it is to be understood that more than 50% of the elongate strands have a longitudinal dimension that is at least twice greater than the dimension perpendicular to the longitudinal dimension (namely, the thickness).

In some examples of the presently disclosed subject matter, the longitudinal dimension of a majority of the plurality of elongate strands is essentially the same as at least one dimension of the product. This can be understood to mean that the longitudinal dimension of at least some of the TVP strand defines at least one dimension of the product.

In some examples of the presently disclosed subject matter the longitudinal dimension in a majority of the plurality of elongate strands is at least 2 cm; at times, at least 2.5 cm; at times, at least 3 cm; at times, at least 3.5 cm; at times, at least 4 cm; at times, at least 4.5 cm; at times, at least 5 cm.

In some examples of the presently disclosed subject matter the thickness dimension in a majority of the plurality of elongate strands is between about 0.2 mm and about 10 mm.

In some examples of the presently disclosed subject matter the thickness dimension in a majority of the plurality of elongate strands is at least 0.2 mm; at times, at least 0.3 mm; at times, at least 0.4 mm; at times, at least 0.5 mm.

In some examples of the presently disclosed subject matter the thickness dimension in a majority of the plurality of elongate strands is at most 10 mm; at times, at most 9 mm; at times, at most 8 mm; at times, at most 7 mm; at times, at most 6 mm; at times, at most 5 mm; at times, at most 4 mm.

In the context of the presently disclosed subject matter, any range between 0.2 mm and 10 mm forms part of the present disclosure, even if the range is not literally and/or explicitly recited.

In some examples of the presently disclosed subject matter, the method comprises placing in a monolayer TVP strands, a majority of which have essentially identical dimensions.

In some examples of the presently disclosed subject matter, the method comprises placing in a monolayer TVP strands that have essentially identical dimensions.

In some examples of the presently disclosed subject matter, a majority of the plurality of elongate strands in a monolayer and/or in the product, have the same length.

In some examples of the presently disclosed subject matter, the method comprises placing in a monolayer TVP strands that have different dimensions. In the context of the presently disclosed subject matter, when referring to different dimensions it is understood to encompass any level of deviation from the average of dimensions. In other words, it may be that essentially each strand has different dimensions than another, it may be that not more than 10% share essentially the same dimensions; at times, not more than 20% share essentially the same dimensions; at times, not more than 30% share essentially the same dimensions; at times, not more than 40% share essentially the same dimensions; at times, not more than 50% share essentially the same dimensions; at times, up to 90% share the same dimensions; at times, up to 80% share the same dimensions; at times, up to 70% share the same dimensions.

In some examples of the presently disclosed subject matter, the method comprises placing in a monolayer TVP strands that differ in their thickness.

The plurality of TVP strands contain water. In some examples, the Whole TVP Strands a priori comprise water; and in some other examples, the Whole TVP Strands are rehydrated by water or with an aqueous medium, e.g. a marinade or emulsion. Rehydration can be achieved by any method known in the art, including soaking, impregnating, spraying, etc.

In some examples of the presently disclosed subject matter, the amount of water in the Whole TVP strands is between about 30% and about 90%; at times, between about 30% and about 80%; at times, between about 30% and 70%; at times between 50% and 80%; at times, between about 40% and 80%; at times, between about 50% and 80%; at times, between about 60% and 80%.

There are different types of TVP that can be employed by the method of the present disclosure.

Without being limited thereto, one example of a TVP extrudate to be used in accordance with the present disclosure is the commercially available product AP-40140 by Henan Pinzheng Food Technology Co. Ltd. (referred to as ZYK). The ZYK type TVP extrudate includes the nutritional facts, as shown in Table 1.

TABLE 1
ZYK TVP Nutritional Facts

| | | |
|---|---|---|
| Tested item | Amount (Per 100 g) | NRV % |

| | | | |
|---|---|---|---|
| Protein (soy) | 67.1 | g | 112% |
| Fat | 07 | g | 1% |
| Carbohydrates | 16.4 | g | 5% |
| Sodium (Na) | 30 | mg | 2% |
| Energy | 1445 | KJ | 17% |

Without being limited thereto, another example of a TVP extrudate to be used in accordance with the present disclosure is the commercially available product TVP-D850 by HUNG YANG FOODS CO., LTD, Taiwan (will be referred as KWN). The KWN type TVP extrudate includes non-GMO isolated soy protein, non-GMO defatted soy flour, wheat flour, corn starch, wheat protein, calcium carbonate, with a minimum of protein (on dry basis) of 60%.

Without being limited thereto, another example of a TVP product to be used in accordance with the present disclosure is the commercially available product TVP-D860 by HUNG YANG FOODS CO., LTD, Taiwan (will be referred as FMB). The D860 TVP extrudate includes a minimum of 57% protein, and the ingredients are wheat protein, non-GMO defatted soy flour, corn starch, wheat flour, calcium carbonate.

Without being limited thereto, another example of a TVP product to be used in accordance with the present disclosure is the commercially available product TVP-QTQ by Yantai Shuangta Food Co. Ltd (will be referred to as QTQ). The TVP extrudate includes at least 80% protein (pea protein).

In some examples of the presently disclosed subject matter, the TVP extrudate that is used as a starting material in the herein disclosed method or in the final whole alt meat product, can be characterized by one or combination of the following features:
Protein content of at least 50% w/w or between 50% w/w and 90% w/w;
Moisture content (before any rehydration) of not more than 15% w/w.
Rehydration capacity of at least 100%, at times, at least 200%; at times, at least 300%; at times, at least 400%; at times, at least 500%; at times, between about 100% and 1,000%, at times 200% and 800%. The rehydration capacity can be determined by rehydrating TVP with extra water (×20 by weight) and weighting it after the saturation is reached (typically after 2 hr.)
Crude fiber content being less than 5%.

In some examples of the presently disclosed subject matter, the method also comprises applying a food grade binding composition.

In some examples, the food grade binding composition is applied over a monolayer prior to applying thereon a subsequent monolayer.

In some examples, the food grade binding composition is applied over at least a portion of the one or more plurality of elongate TVP strands prior to forming therefrom said monolayer.

In some examples, the food grade binding composition is applied over essentially the entire perimeter of the one or more plurality of elongate TVP strands prior to forming therefrom said monolayer.

In some examples, the food grade binding composition is applied over some of the one or more plurality of elongate TVP strands prior to forming therefrom said monolayer and/or over some of the monolayers prior to forming the subsequent monolayer.

In the context of the presently disclosed subject matter, when referring to a food grade binding composition it is to be understood to have a meaning acceptable in the art, i.e. a composition that can promote or facilitate binding of protein based material.

In some examples, the binding composition comprises at least one binding material that is recognized in the art as facilitating adhesion between proteinous matter.

In some examples of the presently disclosed subject matter, the binding material is selected from the group consisting of transglutaminase (TG), carrageenan, locust bean gum (LBG), plant based/derived protein(s) and any combination of same.

In some examples, the binding composition comprises or is gluten.

In some examples, the binding composition comprises TG.

In some examples, the binding composition comprises carrageenan.

In some examples, the binding composition comprises LBG.

In some examples, the binding composition comprises plant derived protein, such as soy protein.

In some examples of the presently disclosed subject matter, the binding composition comprises a combination of gluten with one other binding material.

In some examples of the presently disclosed subject matter, the binding composition comprises a combination of gluten with at least one of transglutaminase (TG), carrageenan, locust bean gum (LBG), plant based/derived protein(s).

In some examples of the presently disclosed subject matter, the binding composition comprises a combination of gluten, soy protein, LBG, carrageenan and TG, in weight amounts of about 40% gluten, about 30% transglutaminase (TG), about 2.5% LBG-carrageenan and about 2.5% soy protein.

It is noted that, at times, when using TG, the amount thereof will be up to 65 ppm. In some examples of the presently disclosed subject matter, the method can also comprise applying at least one strand of protein from high moisture extrusion (HME).

Strand of protein from HME can be obtained by slicing from HME sheets, similar to the way of obtaining strands from whole TVP.

In some examples of the presently disclosed subject matter, the method also comprises introducing into at least one monolayer edible fat.

In the context of the present disclosure, when referring to edible fat, it is to be understood to encompass animal free fat and yet that is suitable for imitating animal fat. In some examples, the edible fat is plant derived fat.

In some examples, the plant derived fat is a food grade oil, fat and/or triglyceride.

In some examples of the presently disclosed subject matter, the method also comprises introducing into at least one monolayer an edible gel.

Once all monolayers are applied, the multi-layered product can be subjected to post construction processes. These include, without being limited thereto, press in cartridge or in a mold, marination, thermal treatment (e.g. light cooking), compactization, subjecting to negative pressure, curing etc.

In some examples of the presently disclosed subject matter, the multi-layered product is subjected to compactization and curing via vacuuming in a bag, e.g. plastic bag, at about 5 mBar

In some examples of the presently disclosed subject matter, the multi-layered product is stored at temperatures below room temperature, e.g. −4° C. or below, at least overnight. In some examples, parameters of the presently disclosed method can be manipulated by properties of the TVP and/or the binding composition.

In some examples of the presently disclosed subject matter, the method parameters can be dictated by characterizing the hardness of a 20 mm cubic specimen produced from bonded rehydrated Whole TVP strands.

Specifically, LLOYD TPA instrument equipped with a 1 KN or 100 N load cell connected to a flat metal plate at the upper fixture and a flat metal bottom fixture can be used, where a 20 mm cubic test specimen is placed at the center of the bottom plate, so that the upper plate is oriented at the center of the test sample. The test was performed at 50 mm/min speed until the upper plate reaches 50% of the sample's height.

The compression test results obtained on 20 mm cubic specimens from exemplary TVP extrudate and different binding compositions are provided in Table 2.

Specifically, the parameters were tested on cubic specimens prepared from a multilayer product produced as described herein (the alternative product). The products differ in at least one of the TVP sources (TVP type), Whole TVP Strand dimension and type of adhesive. The multilayer products were cooked on a pan to reach 70° C. at its core. Each cooked product was then cut into cubes of 20 mm³ with different sources of TVP, different adhesives and/or different Whole TVP Strand thickness.

In this context, when referring to TVP type it is to be understood to refer to TVP extrudates being defined by at least their modulus at their cross over point.

The compression test (to determine the hardness) was performed in two directions. A first direction, “Cross Strands” was conducted with the load being applied perpendicular to the Whole TVP Strands' longitudinal direction in the 20 cm³ cubic specimen; and “Along Strands” was conducted with the load being applied parallel to the Whole TVP Strands longitudinal direction in the specimen. In other words, the test was performed in two configurations: 1. The specimen in the TPA was placed with the strands parallel to the direction of the plate movement (i.e. strands going from top to bottom) 2. The specimen in the TPA was placed with the strands perpendicular to the direction of the plate movement.

Table 2 shows that 3 parameters can contribute to the optimization of the properties of an alternative meat product, so as to better mimic and be comparable (in terms of hardness) to livestock meat (e.g. beef steak). These include, without being limited thereto:
1. Type of adhesive bonding the protein strands
2. TVP type as defined by the cross over modulus of rehydrated TVP extrudates.
3. TVP strands cross section dimension (short dimension).

TABLE 2
Effect of various parameters on hardness of alternative meat 20 cm³cubic samples

| Cross strands compression test | Sample name | TVP type | Adhesive | Strand width^{a} | Hardness [N] |
|---|---|---|---|---|---|
| | Reference meat | — | — | — | 70.6 |
| | Flank steak | | | | |
| Influence of adhesive | ZYK (C)1 | ZYK | Gluten | 2.5 mm | 26.3 |
| | ZYK (C)2 | ZYK | #16^{b} | 2.5 mm | 43.0 |
| Influence of Whole TVP Strands type | ZYK (C)3 | ZYK | #16 | 2.5 mm | 43.0 |
| | FMB (C)4 | FMB | #16 | 2.5 mm | 22.7 |
| Influence of Whole TVP strands width | ZYK (C)5 | ZYK | Gluten | 1 mm | 56.3 |
| | ZYK (C)6 | ZYK | Gluten | 3 mm | 68.5 |

| Along strands compression test | Sample name | TVP type | Adhesive | Strand width | Hardness [N] |
|---|---|---|---|---|---|
| | Reference meat | — | — | — | 35.8 |
| | Hanger steak | | | | |
| Influence of adhesive | ZYK(A) 1 | ZYK | Gluten | 2.5 mm | 17.1 |
| | ZYK(A) 2 | ZYK | 3070^{c} | 2.5 mm | 38.4 |
| Influence of Whole TVP Strands type | ZYK(A) 3 | ZYK | #16 | 2.5 mm | 48.4 |
| | FMB(A) 4 | FMB | #16 | 2.5 mm | 18.4 |
| Influence of TVP strands width | ZYK(A) 5 | ZYK | Gluten | 1 mm | 51.0 |
| | ZYK(A) 6 | ZYK | Gluten | 3 mm | 26.2 |

^{a}the strand's thickness is about 2 mm
^{b}combination of about 40% gluten, about 30% transglutaminase (TG), about 2.5% LBG-carrageenan and about 2.5% soy protein
^{c}30% mTransglutaminase and 70% gluten

In Table 2, Flank steak was chosen as a reference for livestock meat. Under the test conditions applied onto a 20 cm cubic sample of Flank steak, the livestock meat specimen had a hardness of 70.6 N when the cubic sample was placed such that the meat strands of the sample were oriented perpendicular to the direction of compression (Cross Strand), and 35.5 N, when the cubic sample was placed such that the strands of the sample were oriented parallel to the direction of compression (Along strand).

Table 2 shows that the type of TVP, the type of adhesive, and the strand cross sectional dimension in the tested cubic specimen can affect the hardness of the tested specimen under the compression test. Therefore, controlling these parameters could enable higher hardness values, which are desirable in alternative meat products, so as to result in product that better mimic the livestock meat sample, e.g. Flank steak.

Further, Table 2 shows that to obtain a product with livestock meat texture properties, such as hardness, it can be preferable to take into consideration a combination of these parameters.

For example, Table 2 shows that the thickness of the Whole TVP strands (dimension along the short axis of the strand) should preferably be tailored and cannot be set arbitrarily. In the tested samples, it was found that a thickness between 1 to 3 mm, e.g. about 2.5 mm enabled hardness value that resemble that of the referenced livestock meat.

Table 2 also shows that difference in the TVP type can also influence the hardness of the alternative meat product.

Further, Table 2 shows that the type of adhesive used to glue the TVP sliced strands also affects the texture of the product. For example, utilizing 2.5 mm strands of ZYK with 3070 adhesive (30% m-Transglutaminase and 70% gluten) produces hardness of 38.4N when compression was along the longitudinal direction of the strands, which is close to the value of the reference Flank steak (35.8N). Yet, when using only gluten as adhesive, a lower hardness was obtained for the same compression test (17.1N).

It is possible to conclude from Table 2 that the use of an adhesive is advantageous.

A conclusion that may arise from the set of data presented in Table 2 is that when using Whole TVP Strands, it is possible to further tailor the various parameters properly in order to improve the texture to obtain livestock meat properties.

In some examples, the Whole TVP Strands should be selected to provide an alternative meat sample having a hardness of at least 25N or between 25N and 70N when measured cross strand, i.e. perpendicular to the direction of the strands, on a 20 cm specimen, under a compression test as described hereinabove.

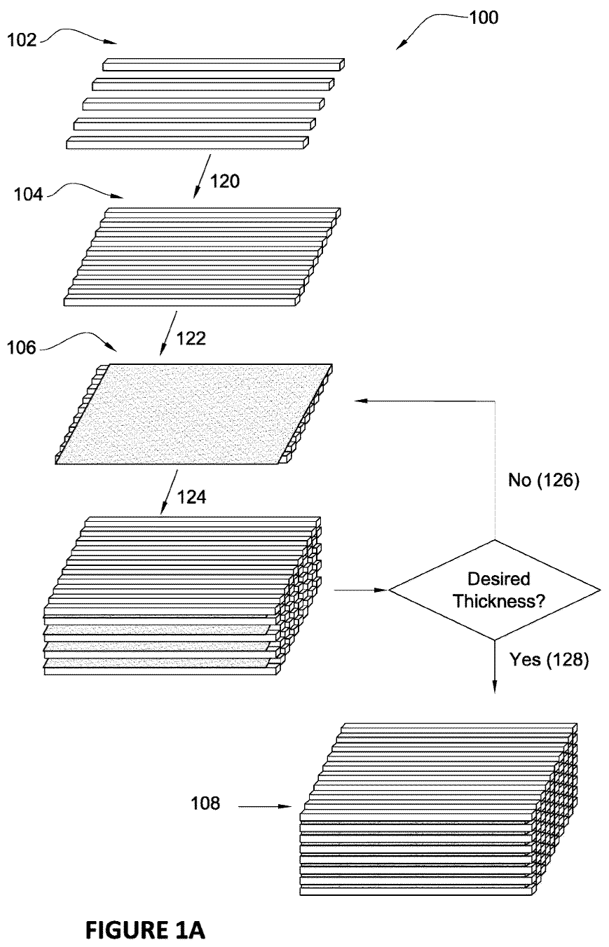

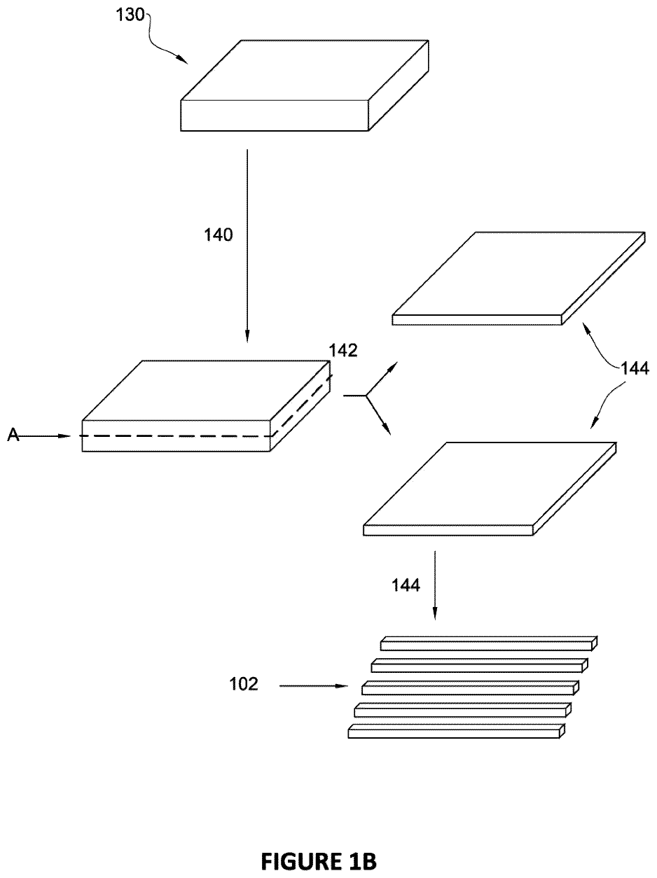

Without being limited thereto, FIG. 1A and FIG. 1B provide a block diagram illustrating the method steps to be taken in order to obtain an alternative food product, and preferably an alternative whole muscle cut product in accordance with some examples of the presently disclosed method.

Specifically, FIG. 1A illustrates method 100 for producing an alternative whole muscle cut product from a plurality of elongate Whole TVP Strands 102. Initially, the elongate Whole TVP Strands 102 are aligned in step 120, in an essentially parallel manner, one with respect to another, to form a monolayer 104.

The monolayer 104 of the plurality of Whole TVP Strands 102 is then covered, in step 122, at least partially with a binding composition 106 such as the aforementioned gluten. The applying of one or more monolayers 104 and a binding composition 106 continues in step 124 whereby a multilayer product 108 is constructed. This step is repeated, as shown in step 126, until a desired multilayer thickness product is obtained in step 126, whereby a slab 108, ready for use, is obtained.

It is to be noted that although in the Example shown in FIG. 1A the strands in the second monolayer are essentially parallel to eh strand in the first monolayer, it does not have to be so. The strands in a monolayer placed on top of the previous monolayer can form an angle with the strands of the previous monolayer. In some examples, the strands in the second monolayer are essentially perpendicular to the previous monolayer. It has been found and presently disclosed that such arrangement may provide added strength to the presently disclosed alternative whole cut muscle product.

Turning now to FIG. 1B, the steps for producing Whole TVP Strands, such as Whole TVP Strands 102 of FIG. 1A are illustrated. Specifically, TVP extrudate 130 is rehydrated in step 140 to provide Whole TVP rehydrate 132. Rehydration can be in water, marinade, an emulsion etc. TVP rehydrate 132 is fileted, in step 142, along line A to provide rehydrated TVP sheets 134 with a thickness adjusted to the desired thickness of the Whole TVP strands. The rehydrated TVP sheets are then sliced, in step 144, the slicing being along the direction of the extrusion of the TVP extrudate (this being identified even by visual (eye) inspection). The slicing in step 144 thus provides a plurality Whole TVP Strands 102.

The presently disclosed subject matter also provides an alternative food product.

In some examples of the presently disclosed subject matter, the alternative food product is an alternative whole muscle cut product.

The food product or alternative whole muscle cut product is obtained or obtainable by the presently disclosed method.

In some examples of the presently disclosed subject matter, there is provided an alternative food product, preferably an alternative whole muscle cut product, comprising a plurality of stacked Whole TVP containing monolayers, each monolayer comprising elongate Whole TVP strands, the majority of which are aligned in a common nominal direction one with respect to another in a monolayer or even in the whole/final product;
wherein upon shearing the product, for about 30 seconds, using a dough blade, the product disintegrates and provides discrete elongate TVP strands having a longitudinal dimension and a thickness dimension, the longitudinal dimension being greater than the thickness dimension; and
wherein the product has a nominal dimension in the nominal direction, and the longitudinal dimension of a majority of the discrete elongate Whole TVP Strands is generally same as the nominal dimension.

The alternative food product of the presently disclosed subject matter, and preferably when the food product is an alternative whole muscle cut product, can also be defined as one that comprises a plurality of stacked TVP containing monolayers, each monolayer comprising elongate strands aligned in a common nominal direction one with respect to another in said monolayer, and preferably in said product;
wherein the product has a nominal dimension in the nominal direction, and the longitudinal dimension of a majority of the discrete elongate TVP strands is generally same as said nominal dimension; and
wherein a load of at least 10N or 25N is required for, respectively 66% or 80% penetration of a 1 mm thick metal plate jig progressed into said food product in a velocity of 50 mm/min, the metal jig being in an orientation that is perpendicular to a nominal direction of elongate strands within the product.

It is to be appreciated that terms used for defining the presently disclosed product, that are common or similarly used with respect to the definition of the presently disclosed method, should be understood to have the same meaning as provided with respect to the herein disclosed method, mutatis mutandis.

In some examples of the presently disclosed product, the majority of the elongate Whole TVP strands are aligned in a common nominal direction one with respect to another in said product. At times, more than 70% of the strands are aligned, at times, more than 80% or even more than 90% are generally aligned in a common nominal direction.

In some examples of the presently disclosed subject matter, the product comprises food grade binding composition.

In some examples of the presently disclosed subject matter, the product comprises edible fat.

In some examples of the presently disclosed subject matter, the product comprises edible gel.

In some examples of the presently disclosed subject matter, the discrete elongate Whole TVP Strands (upon disintegration of the product) maintain their elongate dimension during a 3-point bending test performed as described below.

The herein disclosed product is further characterized, in accordance with some examples of the presently disclosed subject matter, by the load required for penetration into the whole product using a plate jig and a penetration velocity of 50 mm/min.

In some examples of the presently disclosed subject matter, the load required for penetration is determined according to the herein disclosed modified bite test. In the context of the present disclosure, the modified bite test comprises placing a cubic specimen (15 mm×15 mm×15 mm) on a metal platform, progressing towards the platform a 1 mm thick metal plate jig until penetrating the specimen and measuring the load at different penetration depths (% penetration). Penetration velocity is 50 mm/min until reaching penetration of 95%. Orientation of the penetration is such that the metal plate jig is perpendicular to orientation of the whole TVP strands.

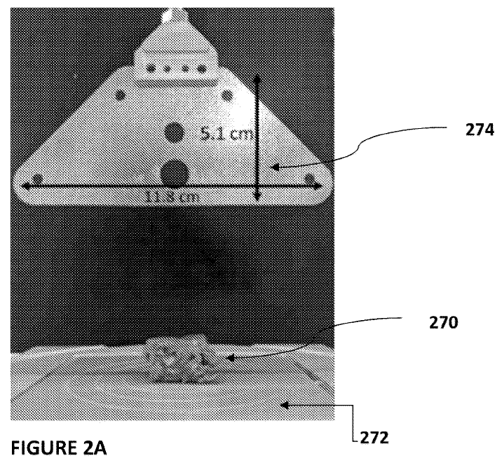

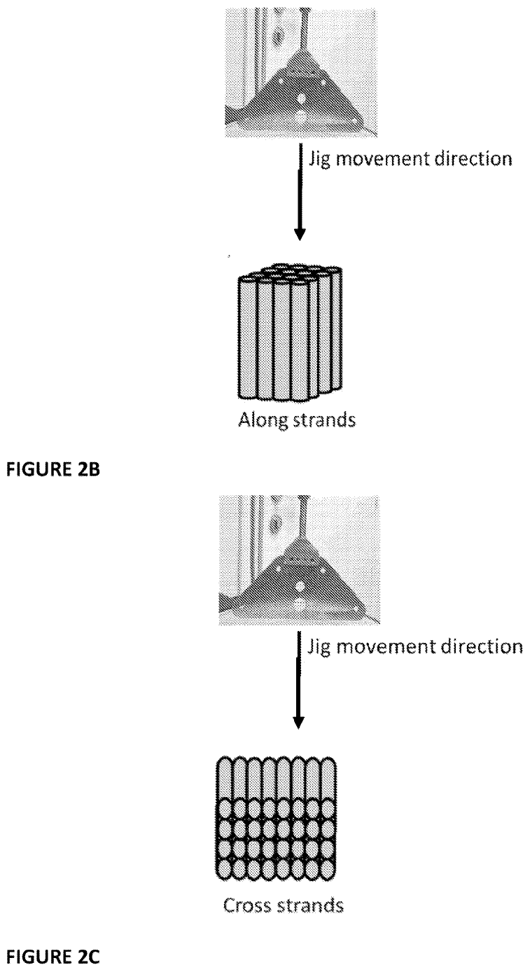

In some examples of the presently disclosed subject matter, the alternative food product, being preferably an alternative whole muscle cut product requires a load of at least 10N for achieving 66% penetration when the plate jig is oriented essentially perpendicular to the direction of the Whole TVP Strands (as illustrated in FIG. 2C).

In some examples of the presently disclosed subject matter, the alternative food product, being preferably an alternative whole muscle cut product requires a load of at least 11N for achieving 66% penetration when the plate jig is oriented essentially perpendicular to the direction of the Whole TVP Strands; at times, of at least 12N; at times, of at least 13N, for achieving 66% penetration when the plate jig is oriented essentially perpendicular to the direction of the Whole TVP Strands.

In some examples of the presently disclosed subject matter, the alternative food product, being preferably an alternative whole muscle cut product requires a load of at least 25N for achieving 80% penetration when the plate jig is oriented essentially perpendicular to the direction of the Whole TVP Strands (as illustrated in FIG. 2C).

In some examples of the presently disclosed subject matter, the alternative food product, being preferably an alternative whole muscle cut product requires a load of at least 30N for achieving 80% penetration when the plate jig is oriented essentially perpendicular to the direction of the Whole TVP Strands; at times, of at least 35N; at times, of at least 40N, for achieving 80% penetration when the plate jig is oriented essentially perpendicular to the direction of the Whole TVP Strands.

The resulting food product, preferably an alternative whole muscle cut product disclosed herein or produced by the method disclosed herein exhibited unique properties including at least one, at times at least more than one of the following: (i) high bite resistance strength in direction perpendicular to the strands longitudinal direction as further described below, (ii) high anisotropy (which is exhibited, inter alia, by the bite resistance strength), (iii) disintegration into strands when broke down, the longitudinal dimension of the strands being at least twice greater than one other dimension of the strand (i.e. elongate strands), (iv) when a frozen sample is bent in direction perpendicular to the direction of the TVP elongate strands, there is no catastrophic failure at the point of bending, (v) high grain morphology (high fibrous morphology) when broken apart using a 3-point bending test (using LLOYD TPA instrument. Specifically, the different samples were frozen to −18° C. after which a 3-point bending test was conducted in accordance with the following procedure: a 15×10×150 mm specimen was placed at a fixture with 60 mm span (distance between the support points) and a force was applied at 10 mm/min deflection rate till failure using LLOYD TPA instrument equipped with 1 KN load cell and (vi) organoleptic characteristics resembling those of livestock meat as determined by a trained sensory panel.

In the context of the presently disclosed subject matter, it is to be understood that a “catastrophic failure” is one that results in the complete separation between two parts of a tested sample upon applying a force onto the sample in a 3 point bending test; while a “non-catastrophic failure” is one that results in having two sides of the tested sample that are partially connected and flank the area upon which the force was applied connected.

As used herein in the specification and in the claim, the forms “a”, “an” and “the” include singular as well as plural references unless the context clearly dictates otherwise. For example, the term “a protein” includes one or more proteins, e.g. forming part of a texturized vegetable protein (TVP).

As used herein in the specification and in the claim, the form “and/or,” should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined.

Further, as used herein, the term “comprising” is intended to mean that a recited element, e.g. monolayer, includes the recited components, e.g. TVP strands, but not excluding other elements, such as non-TVP elements, e.g. binding composition. The term “consisting essentially of” is used to define elements which include the recited components but exclude other components that may have an essential significance on the functionality of the element. “Consisting of” shall thus mean excluding more than trace amounts of other components in an element. Embodiments defined by each of these transition terms are within the scope of this invention.

Further, as used herein, the term “essentially” or “generally” or “substantially” is intended to mean that a defined property or element can have 10% deviation from the recited value. For example, strands that are essentially parallel, should be understood to mean that at least 90% of the strands are aligned.

Further, as used herein, the term “majority” is intended to mean any amount above 50%; at times, above 60%; at times above 70%; at times above 80%; at times above 90%.

Further, as used herein, the term “about” is intended to mean that all numerical values, e.g. amounts or ranges, are approximations which are varied (+) or (−) by up to 20%, at times by up to 10% of from the stated values.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### Examples

### Preparation of Alternative Meat Products

TVP extrudates (manufacturer Hung Yang Foods) were used as starting material and are identified as ZYK, KWN, and QTQ (manufactured by Yantai Shuangta Food Co., Ltd).

The different TVP sheets were rehydrated by soaking in water or in a marinade comprising about 13 wt % plant based oil and about 80 wt % water (the rest being salts and flavors), at a TVP to liquid ratio as defined in Table 3 below.

TABLE 3
Rehydration of dry TVP

| | | | | | % wt^{a} liquid | | |
|---|---|---|---|---|---|---|---|
| | Weight of | Weight of | | Weight of | absorbed per | | Time of |
| | TVP | TVP | Weight of | TVP after | total weight of | Ratio | absorption, |
| | extrudate, g | extrudate, % | liquid, g | soaking, g | rehydrated TVP | emulsion/TVP | hour |
| ZYK | 14.92 | 100.00 | 50.47 | 51.20 | 243.27 | 3.38 | 24.0 |
| KWN#1 | 7.94 | 100.00 | 25.44 | 31.45 | 296.62 | 3.21 | 2.0 |
| KWN#2 | 8.5 | 100.00 | 22.95 | 30.31 | 256.61 | 2.7 | 2.0 |
| KWN#3 | 8.19 | 100.00 | 22.12 | 28.23 | 239.09 | 2.70 | 3.0 |
| KWN#4 | 9.68 | 100.00 | 30.96 | 33.79 | 248.99 | 3.20 | 6.0 |
| KWN#6 | 9.65 | 100.00 | 30.86 | 37.50 | 288.75 | 3.20 | 6.0 |
| QTQ | 13.32 | 100.00 | 45.02 | 56.11 | 321.25 | 3.38 | 2.0 |

^{a}(F − C)*100/C(Weight of TVP after soaking − Weight of TVP before soaking)*100/Weight of TVP before soaking

For rheological tests on rehydrated TVP extrudates, each rehydrated TVP sheet was rehydration at a weight ratio of 1:2.1 with water.

In addition, HME protein sheets containing soy as a main protein source were used.

For determining the effect to using elongate dry TVP on the resulting meat analogue product, the following different test samples were prepared. All strands in the following non-limiting examples had a length of about 5 cm and 20 cm and a thickness of about 2±1 mm:

Whole Strands ZYK prepared according to the process of this disclosure (FIG. 1B), using ZYK TVP (commercially available product AP-40140 by Henan Pinzheng Food Technology Co. Ltd.).

Whole Strands KWN #1 prepared according to the process of this disclosure (FIG. 1B) using KWN TVP

Whole Strands KWN #2 prepared according to the process of this disclosure (FIG. 1B) using KWN TVP.

Whole Strands KWN #3 prepared according to the process of this disclosure (FIG. 1B) using KWN TVP.

Whole Strands KWN #4 prepared according to the process of this disclosure (FIG. 1B) using KWN TVP.

Whole Strands KWN #6 prepared according to the process of this disclosure (FIG. 1B) using KWN TVP.

It is noted that KWN #1, KWN #2, KWN #3 and KWN #4, and KWN #6 have essentially the same chemical composition. Yet, these different TVP extrudates differ at least in their cross over modulus, determined as described herein.

Whole Strands QTQ prepared according to the process of this disclosure (FIG. 1B) using QTQ TVP.

HME slab was prepared according to the process of this disclosure (FIG. 1B) using HME instead of TVP.

HME/TVP slab was prepared according to the process of this disclosure (FIG. 1B) using 50/50 HME/TVP instead of TVP.

In addition, for comparison, the following Reference samples were used: “Chopped Strands” sample prepared according to WO2020/152689 where TVP were chopped, and protein strands are created by extrusion of the chopped TVP.

Meat Sirloin-livestock rSirloin meat sample cut to a dimension of 15 mm×15 mm×15 mm

Meat Tenderloin-livestock Tenderloin meat sample cut to a dimension of 15 mm×15 mm×15 mm

Commercial Alt burger product by Beyond Meat® cut to a dimension of 15 mm×15 mm×15 mm.

### Preparation of Alternative Whole Muscle Cut Analogue—Test Samples

The alternative whole muscle cut samples were prepared by layering, one on top of the other of monolayers of parallelly aligned Whole TVP Strands, a priori coated with a binding composition (typically gluten powder), until receiving the desired dimensions of the slab (the whole muscle cut analogue). The slab was then placed in a vacuum bag subjected to negative pressure of 5 mBar for compactization. The compacted product was then stored at 4° C., over night, before performing any tests thereon.

To test the different whole muscle cut samples, each was cooked by searing @ 170° C. until the internal part of each sample reaches 70° C. The samples were then cooled to room temperature (RT) and cut into 15 mm×15 mm×15 mm cubes. When using Whole Strands samples, the strands were aligned with an orthogonal axis of the cubes.

In case outer crust is formed, it is preferably removed.

### Modified Bite Test

A modified bite test was performed with a texture profile analyzer (TPA) instrument (Lloyd instruments, TA1) equipped with a 1 KN load cell connected to a 1 mm thick metal plate jig at the upper fixture and a flat metal bottom fixture (FIG. 2A).

In operation, each test or reference sample 270 was placed at the center of the metal bottom platform 272 (of the TPA) the upper plate is oriented at the center of the test sample, and the 1 mm thick metal plate jig 274 progressed toward the platform 272, until penetrating the sample 270. The load at various penetration depths was measured by the TPA sensor. More specifically, the penetration was at a velocity of 50 mm/min until a strain of 95% was reached. The load was measured and recorded at 66.6% or 80% strains.

The tests for the different samples were performed in two different orientations in relation to the metal plate jig—(a) “along strands”, in which the metal plate jig cut the sample in direction parallel to the direction of the protein strands (either the Whole Strands or the Chopped Strands) in an alternative whole muscle cut sample or in direction of the protein strands in the livestock meat sample; and (b) “cross strands”, in which the plate jig cut the sample in direction 90° to the direction of the protein strands (FIG. 2B).

### Results:

### Behavior of Samples Listed Below

The measurements were performed on cubic samples 15 mm×15 mm×15 mm, for two penetration depths—that were 66.6% and 80%, and Tables 4 and 5 provide a comparison between the properties of meat alternative sample produced with strands of chopped TVP (i.e. Chopped TVP Strands, as described also in WO2020/152689) with that of alternative whole muscle cut produced with Whole TVP Strands as disclosed herein, at both penetration depths. Tables 4 and 5 show that the alternative whole muscle cut products obtained from the Whole Strands require significantly higher loads in order to reach the same level of penetration, i.e. 66.6% or 80% penetration.

In addition, Tables 4 and 5 show that there is a difference in the load required with the two different orientations in relation to the metal plate jig, i.e. a higher load when the metal plate jig has an orientation that crosses the orientation of the protein stands.

TABLE 4
Load [N] at 66.6% penetration - Modified
Bite Test on Final Products

| | Direction in TPA | |
|---|---|---|
| Test sample | Along strands | Cross strands |
| Slab from Chopped TVP Strands | 3.1 ± 0.8 | 9.1 ± 0.3 |
| Slab from Whole TVP Strands ZYK | 3.6 ± 0.5 | 23.3 ± 5.0 |
| Slab from Whole TVP Strands KWN#1 | 3.2 ± 0.9 | 17.3 ± 2.6 |
| Slab from Whole TVP Strands KWN#2 | 1.3 ± 0.6 | 8.0 ± 1.3 |
| Slab from Whole TVP Strands QTQ | 2.7 ± 0.2 | 13 ± 2.6 |
| Slab from HME | 13.2 ± 3.1 | 19.6 ± 1.3 |
| Slab from HME/ Whole TVP Strands | 2.8 ± 0.6 | 19.0 ± 4.5 |
| Meat Sirloin | 32.8 ± 3.9 | 42.1 ± 14.2 |
| Meat Tenderloin | 25.04 ± 4.2 | 49.1 ± 0.2 |
| Commercial Alt meat (“Beyond” burger) | 1.47 ± 0.8 | — |

TABLE 5
Load [N] at 80% penetration - Modified
Bite Test on Final Products

| | Direction in TPA | |
|---|---|---|
| Test sample | Along strands | Cross strands |
| Slab from Chopped TVP Strands | 1.85 ± 0.6 | 9.1 ± 1.1 |
| Slab from Whole TVP Strands ZYK | 4.1 ± 0.6 | 61.8 ± 18.0 |
| Slab from Whole TVP Strands KWN#1 | 4.1 ± 1.4 | 41.0 ± 9.7 |
| Slab from Whole TVP Strands KWN#2 | 1.33 ± 0.7 | 20.6 ± 3.7 |
| Slab from Whole TVP Strands QTQ | 2.9 ± 0.1 | 26.4 ± 4.1 |
| Slab from HME | 13.3 ± 2.7 | 23.3 ± 2.7 |
| Slab from HME/ Whole TVP Strands | 3.04 ± 1.0 | 32.5 ± 6.3 |
| Meat Sirloin | 43.3 ± 6.6 | 57.1 ± 8.9 |
| Meat Tenderloin | 39.5 ± 1.4 | 46.6 ± 4.6 |
| Commercial Alt meat (“Beyond” burger) | 2.2 ± 0.8 | — |

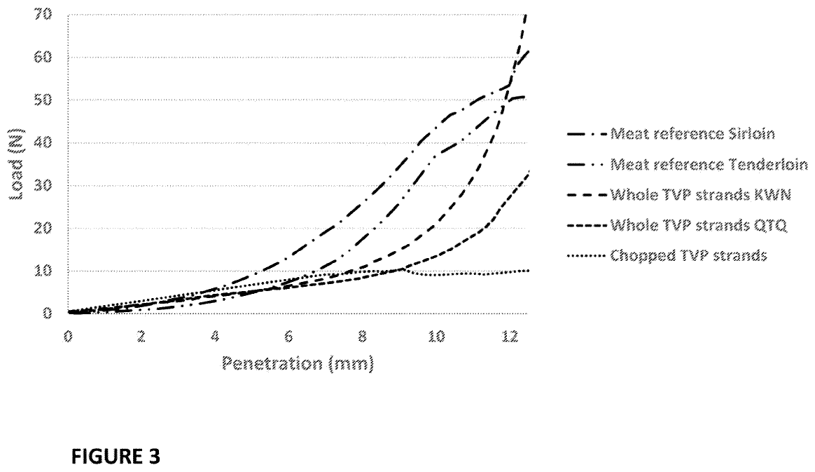

Further, FIG. 3 provides the penetration curve of the Whole Strands sample from Whole TVP KWN #1, and that of the Chopped Strands Sample.

Specifically, FIG. 3 shows for the Whole TVP Strands sample a sharp increase in load, then a plateau, which is believed to be due to smooth penetration of the plate into the sample. At 66% penetration depth (namely—about 10 mm deep into the sample), there was a substantial increase of the measured load, possibly due to the change of the compression mode of the sample, where the strands cannot slip aside and were sheared or cut. The penetration curve of the Chopped Strands sample (the sample based on WO2020/152689) also presented in FIG. 3, demonstrates high penetration load during initial penetration (load of 6N), and then a drop that may indicate a fracture of the sample.

To summarize, Tables 4 and 5 and FIG. 3 teach that the whole muscle cut analogue disclosed herein, obtained from Whole TVP Strands, provide resistance to bite in direction perpendicular to the direction of the strands that is above 24N at 80% penetration and above 10N at 66.6% penetration.

Moreover, the anisotropy degree that can be defined as the ratio between the measurement perpendicular the direction of the strands and the measurement parallel to the direction of the strands is shown to be about 10 and above in Table 5 (load at 80% penetration), as opposed to the other samples prepared from Chopped TVP Strands or HME only, where this ratio was significantly lower.

### Fracture Behavior of Frozen Samples

The different samples were frozen to −18° C. after which a 3-point bending test was conducted in accordance with the following procedure: a 15×10×200 mm specimen was placed at a fixture with 60 mm span and a load was applied at 10 mm/min deflection rate till failure.

It is noted that the reason for freezing the samples prior to applying the 3-point bending test was to ensure a fracture phenomenon instead of a tearing phenomenon of the tested sample. In other words, freezing before applying the bending test allows a catastrophic failure along the 3-point bending axis without elongation of the sample around of the bending axis (the elongation being characteristic of the tearing phenomenon).

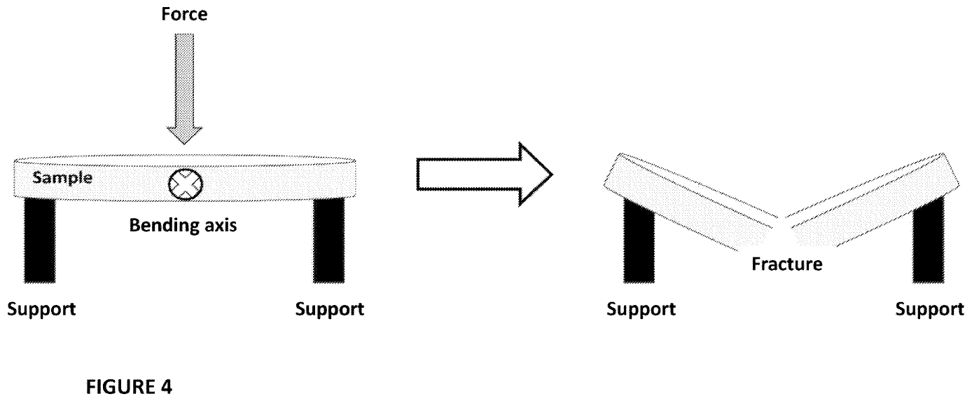

The 3-point bending test is schematically illustrated in FIG. 4.

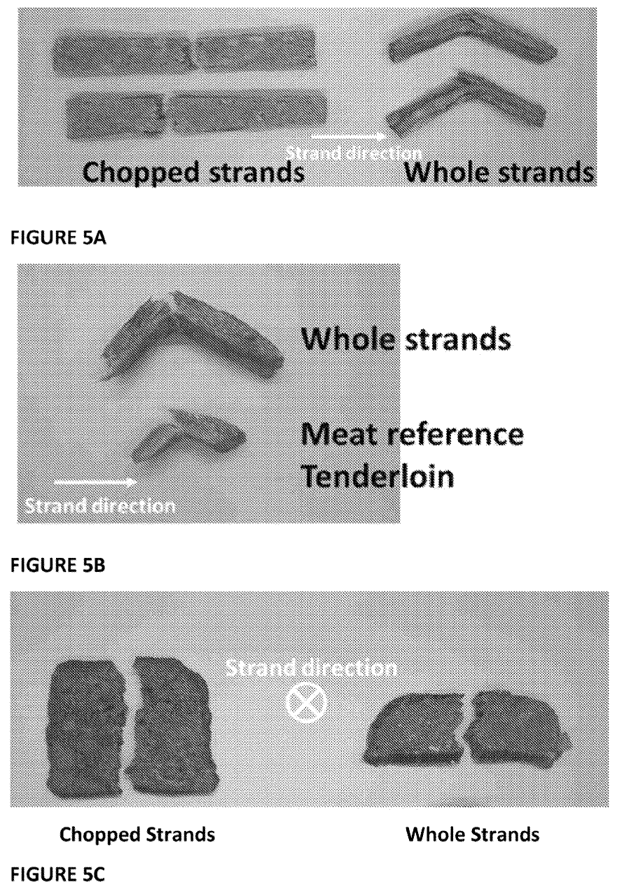

FIG. 5A provides images of the different samples after applying the 3-point bending test in a direction perpendicular to the direction of the strands forming the samples. Specifically, FIG. 5A shows the fracture/failure behavior between the different tested samples until reaching a catastrophic failure, where with samples constructed from strands of chopped TVP, there is a complete fracture, while when applying the test on the samples constructed from strands of whole TVP, under the same conditions as with the “Chopped TVP Strands” the sample did not reach a catastrophic failure and the strands remained essentially intact. The Whole TVP Strand sample in fact behaves similarly to a beef tenderloin sample as shown in FIG. 5B.

It is believed that this difference in behavior is a direct result of using strands sliced directly from Whole TVP Strand, namely, where the extrusion direction of the protein mass in the original TVP sheet is maintained, thus maintaining a fibrous texture without the need to actually extrude TVP dough into TVP strands.

FIG. 5C shows that when applying the test in direction parallel to the direction of the strands, there is no difference between the two tested samples, namely, the Whole TVP Strand sample and the Chopped TVP Strand sample.

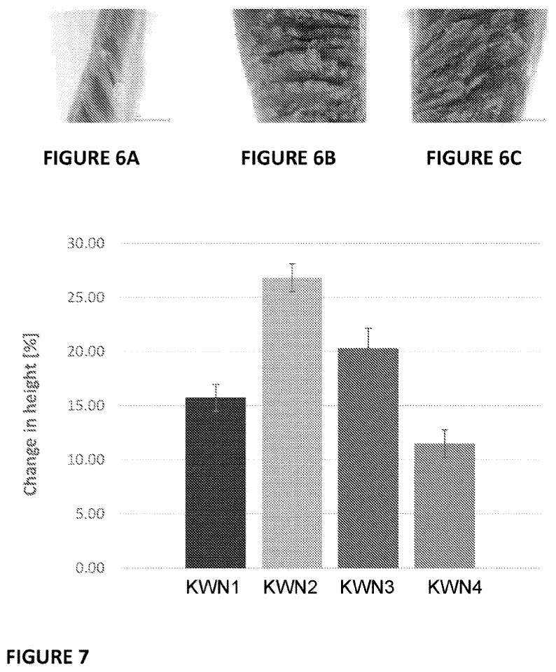

For further illustration the resemblance between the texture of the alternative meat sample from Whole Strands, and that of livestock meat, reference is made to FIGS. 6A-6C providing top view photos of the 3-point bending test failure area in meat sirloin reference sample (FIG. 6A), meat tenderloin reference sample (FIG. 6B) and in alternative meat sample comprising Whole Strands (FIG. 6C). The resemblance between Whole TVP Strands sample and the livestock meat samples, namely, the Sirloin and Tenderloin meat reference samples is clearly visible, showing morphologically, at the fracture axis, internal layers of protein mass, one on top of the other, similarly resembling “plate-like structures”.

### Rheometer

The different rheological tests were conducted on Whole TVP extrudate samples cut into 30 mm diameter circular discs.

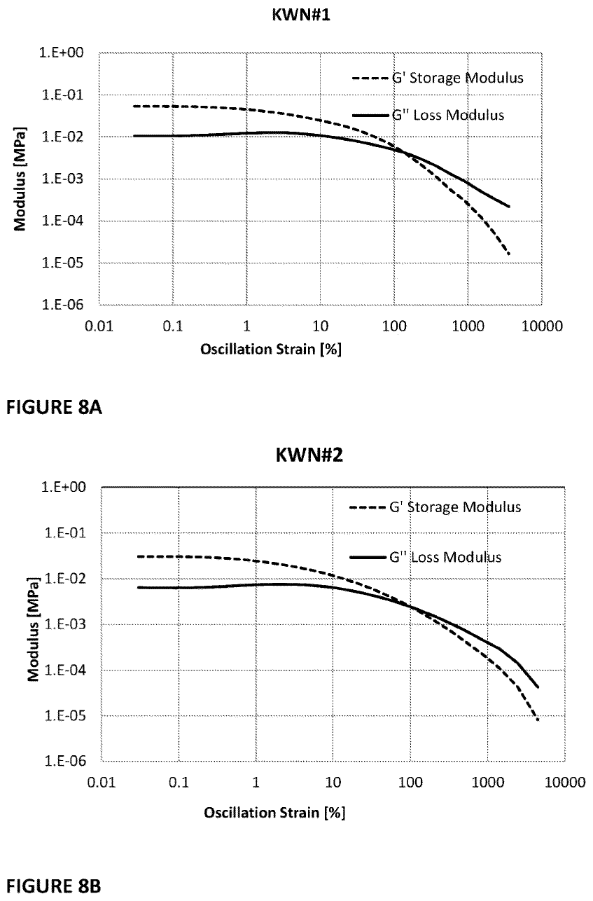

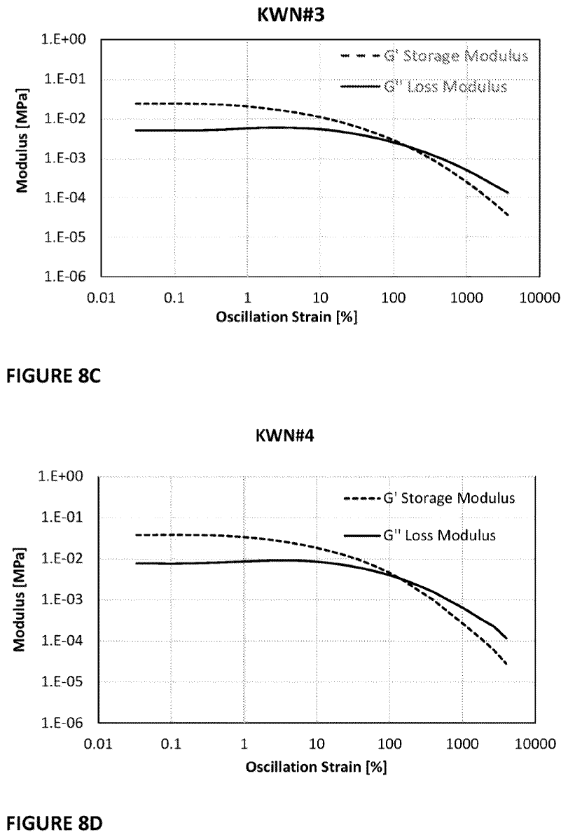

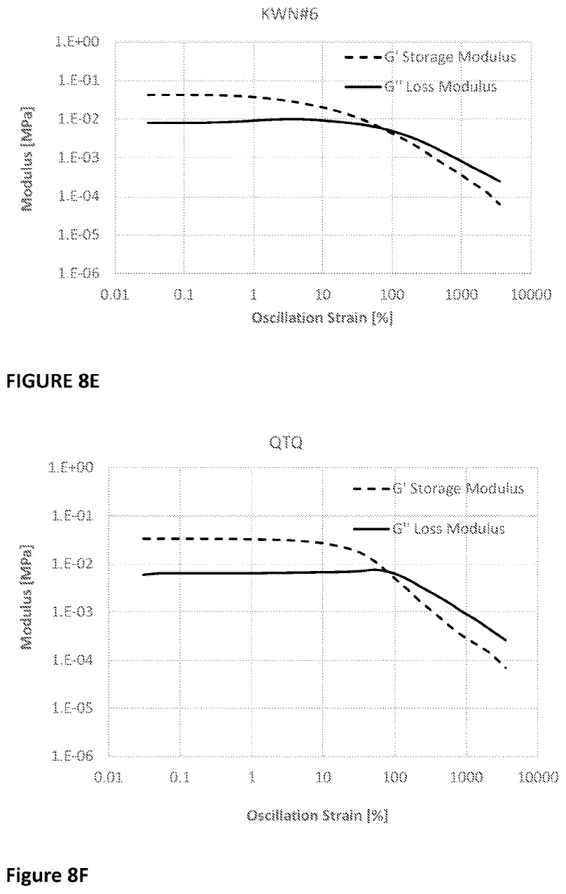

The test examples were prepared from TVP extrudates that while having essentially the same protein composition, differ in their cross over modulus, as described with respect to FIGS. 8A-8F.

The test samples were prepared as follows:

Dry TVP sheets (the extrudates, as obtained from the manufacturer) were immersed in a plastic bag containing TVP to water weight ratio of 1:2.1. The plastic bag was vacuum sealed and was left for 2 hours, at room temperature for allowing the dry TVP to soak with the water. Then, the hydrated TVP samples were removed from the water and cut into discs using a 30 mm diameter circular cutter.

The rehydrated TVP disc samples were subjected to two different rheological tests: Compression Test and Amplitude Sweep test (to determine crossover modulus).

### Compression Test

The compression test was conducted by using the LLOYD Texture Analyzer, under the following conditions: cubic samples of 30 mm×30 mm×30 mm were subjected to two compression cycles, 80% each, at a speed of 120 mm/min.

The compression test is aimed at determining the elasticity of the different samples as per the change in the sample's height measured after a first compression. A more plastic sample is determined when the extent of change is greater (i.e. less elastic sample). Notably, for a sample to resemble livestock meat, it should be less plastic, i.e. return to its original dimensions upon compression.

FIG. 7 is a graph showing the % change in height of the different samples upon rehydration with water at a ratio of 1:2.1. The results indicate that KWN #1 and KWN #4 are the more elastic (better texture) as compared to KWN #2 or KWN #3.

### Crossover Modulus

These rheological tests were conducted as described by Valerie Louise Pietsch, Fritz Soergel and Mattia Giannini in ThermoFisher Scientific No. WP04 0321 with some modifications. Specifically, all measurements were carried out at room temperature, conducted with a Rheometer equipped with a parallel plate 40 mm geometry, upper geometry sandblasted stainless steel and bottom aluminum equipped with peltier plate. For the Amplitude Sweep Test the disc samples were loaded into the measuring geometry by applying a constant normal force of 25N. After reaching a constant normal force, oscillatory measurements were conducted using a strain γ of 3·10⁻²-3·10³% and a constant frequency f of 10 rad/sec.

A crossover modulus is the frequency at which the elastic and viscous moduli cross, usually marking the transition from the terminal (viscous) region to the rubbery plateau (elastic) region. In other words, it is the point of balance where G′=G″. Before reaching this point a tested sample is considered to be solid-like (G′>G″) and reaching this point, a tested sample is considered to be liquid-like (G′<G″).

Without being bound by theory, it is believed that the determination of the crossover point would allow to distinguish between types of TVP, that would provide final product that would mimic livestock meat in terms of texture, chewiness etc.

FIGS. 8A-8F provide the storage modulus (G′) and loss modulus (G″) for KWN #1, KWN #2, KWN #3, KWN #4, KWN #6 and QTQ samples. Notably, each curve is an average of 4-5 measurements.

Generally, in the Linear Viscoelastic Region (LVR) storage and loss modulus G′ and G″ are constant and independent of the applied deformation. The width of the LVR depends on the structural strength of the material. A change in storage and loss modulus indicates that the applied deformation exceeds the LVR, causing a change in the samples structure. After a certain deformation, the non-linear deformation starts with a non-linear increase in loss modulus G″ and is then followed by the cross-over of G′ and G″. Thus, the cross-over point is defined by the balance of G′=G″. Before this point the samples are solid-like (G′>G″) and after it they are liquid-like (G′<G″).

Table 6 provides the crossover points for the different samples.

TABLE 6
Crossover points

| | | Oscillation Strain [%] | Modulus [KPa] |
|---|---|---|---|
| KWN#1 | Average | 140.47 | 4.18 |
| | stdev | 18.92 | 0.945 |
| KWN#2 | Average | 112.78 | 2.23 |
| | stdev | 20.62 | 0.364 |
| KWN#3 | Average | 152.96 | 2.01 |
| | stdev | 23.9 | 0.174 |
| KWN#4 | Average | 116.6 | 3.61 |
| | stdev | 6.36 | 0.531 |
| KWN#6 | Average | 75.9 | 5.53 |
| | stdev | 18.72 | 1.28 |
| QTQ | Average | 82.62 | 6.8 |
| | stdev | 9.22 | 0.9 |

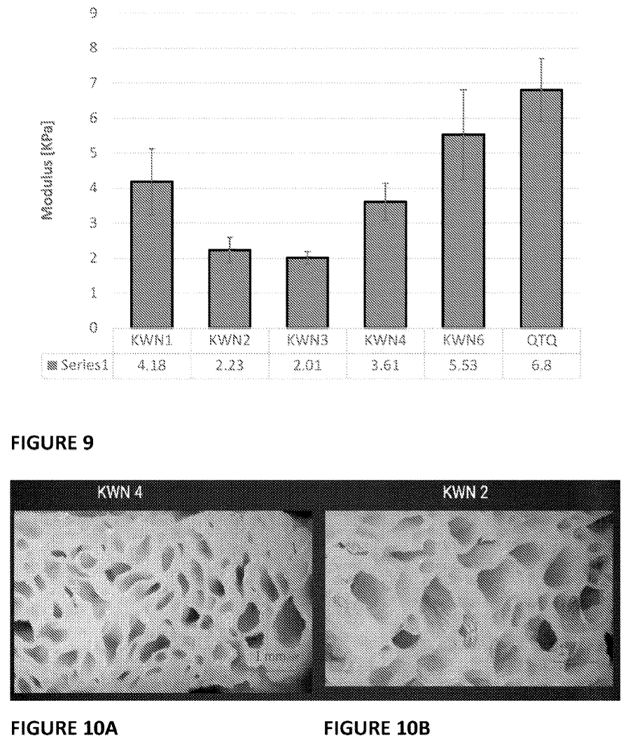

FIG. 9 presents that above data in a bar graph. As evident from Table 1 and FIG. 9, the crossover modulus of KWN #1 and #4 were similar and significantly higher than those of KWN #2 and #3. Generally, modulus is correlated with stiffness. Therefore, it is to be understood that KWN #1 and #4 are also stiffer/denser (probably due to the denser structure as shown in FIG. 10A vs. FIG. 10B), which is consistent with their cross over modulus values.

The above results were also in line with the conclusions of a trained sensory panel. The sensory panel determined that the slabs produced from KWN #1 and KWN #4 had a greater chewiness and hardness, as compared with KWN #2 and KWN #3, and thus resembled better livestock meat texture.

To further illustrate the difference between KWN #2 (that is considered a less favorable TVP type) and KWN #4 (considered a more favorable TVP type), optical microscope images of the two strands were taken. The images show that the strand from KWN #4 is more dense, less porous (smaller pore size), which probably contributed to the improved texture as shown in FIGS. 10A-10B

### Disintegration Test

The goal of the disintegration test was to identify sub-structures that are formed when a test sample is put under shear forces (Ninja blender model CT-683 is with dough blade, run at low speed, for 30 sec, low speed being defined by the manufacturer).

Specifically, samples from Whole TVP Strands and the sample from Chopped TVP Strands were defrosted and brought to 25° C. A 20 mm slice was cut perpendicular to the direction of the strands, and the samples' weight was recorded. The parameters are summarized in Table 6:

TABLE 7
Alternative whole muscle cut analog Properties from
Whole TVP or Chopped TVP strands (FIGS. 11A-11E)

| Property | Whole Strands | Chopped Strands |
|---|---|---|
| Thickness | 20 mm | 20 mm |
| Weight | 65.6 gr | 69.6 gr |
| Discrete elongate strands on filter | Yes | No |
| Mass of strands on filter | 57.3 gr | 0 |
| Mass of remaining material | 31.1 gr | 72.2 gr |

Each slice was then placed within a 2 L bowl of a CT683 is Ninja Blender equipped with a dough blade. One liter of tap water was added, and the blender was activated at low speed. The sample within the bowl was thus subjected to shear forces for 30 seconds.

After blending the resulting blended matter was poured into a 1 mm kitchen filter and washed with tap water. The filtered mass was transferred onto a working surface.

FIG. 11A shows that the shear forces caused disintegration of the Whole TVP Strands such that in the samples prepared from Whole TVP Strands, the test resulted in discrete elongate TVP strands, with an average length of ˜20±2 mm (FIG. 11A-11B). The sample formed of Chopped TVP Strands, i.e. made after chopping the TVP extrudate and from the chopped TVP, preparing strands, disintegrated into dense amorphous pieces of TVP, resembling minced meat (FIGS. 11D-11E).

Samples made from Whole TVP Strands are characterized by the integrity of the strands upon disintegration of the product.

FIG. 11B shows that even if the whole muscle cut analogue product, prepared from Whole TVP Strands, was cut into a size of a steak, it disintegrated (in the above described process) into discrete essentially identical strands with length equal to the thickness of the steak.

FIG. 11C provides an image of disintegrated alternative whole muscle cut analogue, with the Whole strands having a length ranging from about 6 cm and 15 cm.

### Imaging

To verify the existence of pores within a Whole TVP Strand product, and on the other hand, their absence in a product from Chopped TVP, cross sectional cuts of slabs from Whole TVP Strands, produced in accordance with the present disclosure, and from Chopped TVP were taken.

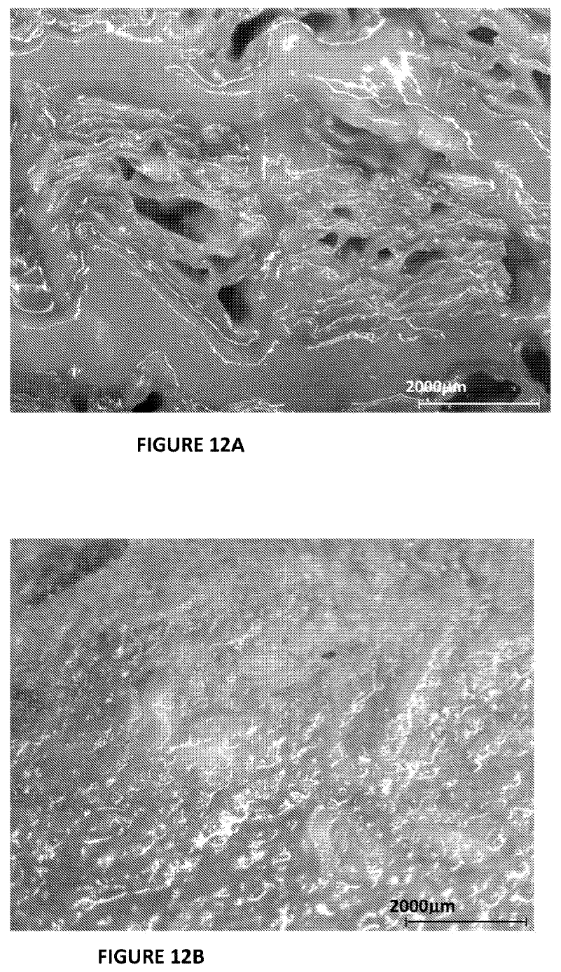

FIG. 12A and FIG. 12B are microscope image of a cross section of a product obtained from Whole TVP Strands (FIG. 12A) and from Chopped TVP (FIG. 12B). The existence of pores in the Whole TVP strand product is evident from FIG. 12A, while the absence of such pores is evident from FIG. 12B.

1-47. (canceled)

48. A method for producing an alternative food product, the method comprising:
providing a plurality of elongate texturized vegetable protein (TVP) strands;
forming a first monolayer of essentially parallelly aligned elongate TVP strands; and
forming at least one additional monolayer of essentially parallelly aligned elongate TVP strands, each additional monolayer formed over a previously formed monolayer;
wherein a rehydrated sample of TVP extrudate from which said plurality of TVP strands are formed, has a crossover modulus of at least 2.5 KPa as determined, at 25° C., in an Amplitude Sweep mode, from 3·10⁻²% to 3·10³%, at a constant frequency of 10 rad/s and a constant axial force of 25 N.

49. The method of claim 48, wherein said plurality of elongate TVP strands are rehydrated TVP strands.

50. The method of claim 48, wherein each of said plurality of elongate TVP strands have a strand longitudinal dimension and a strand thickness dimension, the strand longitudinal dimension being measured in direction essentially parallel to direction of extrusion of said TVP extrudate and wherein said thickness dimension is measured in a direction perpendicular to the direction of extrusion of said TVP extrudate.

51. The method of claim 48, wherein said plurality of elongate TVP strands are strands sliced out of a sheet of TVP extrudate, the slicing being in a direction essentially parallel to direction of extrusion of said TVP extrudate.

52. The method of claim 48, wherein each of said plurality of elongate TVP strands includes elongate pores having a longitudinal direction that correlate with direction of extrusion of said TVP extrudate.

53. The method of claim 50, wherein said longitudinal dimension in a majority of said elongate strands is at least twice greater than the thickness dimension; and wherein at least one of the following is fulfilled: (i) said longitudinal dimension in a majority of said elongate strands is at least 2 cm; (ii) said thickness dimension in a majority of said elongate strands is between 0.2 mm and 10 mm; and (iii) said thickness dimension of a plurality of TVP strands in a monolayer is generally the same.

54. The method of claim 48, further comprising rehydrating TVP extrudate with a liquid and slicing the rehydrated TVP extrudate into said TVP strands.

55. The method of claim 54, further comprising rehydrating with the liquid at a weight ratio between said TVP extrudate and said liquid of between 1:1.5 and 1:5.

56. The method of claim 48, wherein the plurality of elongate TVP strands have a water content of between about 30 wt % and 90 wt % or between about 60 wt % and 80 wt %.

57. The method of claim 48, further comprising applying a food grade binding composition over a monolayer prior to applying thereon a subsequent monolayer and/or applying a food grade binding composition over one or more of said plurality of elongate TVP strands prior to forming therefrom said monolayer.

58. The method of claim 48, further comprising combining said TVP strands with at least one strand of protein from high moisture extrusion (HME).

59. The method of claim 48, further comprising introducing into at least one monolayer edible fat and/or edible gel.

60. The method of claim 48, further comprising introducing in between at least two monolayers edible fat and/or edible gel.

61. The method of claim 48, wherein a multilayer product is obtained, said method comprises subjecting the multilayer product to at least one post construction process selected from the group consisting of compactization, curing, thermal treatment, marination, pressing, subjecting to negative pressure.

62. An alternative food product, comprising:
a plurality of stacked TVP containing monolayers, each monolayer comprising elongate strands aligned in a common nominal direction one with respect to another in said monolayer,
wherein upon shearing said product, for about 30 seconds, using a dough blade, the product disintegrates and provides discrete elongate TVP strands having a longitudinal dimension and a thickness dimension, the longitudinal dimension being greater than the thickness dimension; and
wherein said product has a nominal dimension in said nominal direction, and the longitudinal dimension of a majority of the discrete elongate TVP strands is generally same as said nominal dimension.

63. The alternative food product of claim 62, wherein said elongate TVP strands are aligned in a common nominal direction one with respect to another in said product.

64. The alternative food product of claim 62, wherein at least one of the following properties is fulfilled: (i) a load of at least 10N is required for 66% penetration of a 1 mm thick metal plate jig progressed into said food product in a velocity of 50 mm/min, the metal jig being in an orientation that is perpendicular to a nominal direction of elongate strands within the product and (ii) a load of at least 25N is required for 80% penetration of a 1 mm thick metal plate jig progressed into said food product in a velocity of 50 mm/min, the metal jig being in an orientation that is perpendicular to a nominal direction of elongate strands within the product.

65. The alternative food product of claim 62, further comprising optically visible pores throughout a cross section of the product when said cross section is taken perpendicular to nominal direction of the elongate strands within the product, said pores have at least one dimension of at least 0.2 mm.

66. The alternative food product of claim 62, wherein upon disintegration of the product, the total weight of the discrete elongate strands is at least 50% out of a total weight of product before disintegration and/or wherein upon disintegration of the product, the total weight of the discrete elongate strands is at least 50% out of a total weight of product before disintegration.

67. An alternative food product, comprising:
a plurality of stacked TVP containing monolayers, each monolayer comprising elongate TVP strands having a longitudinal dimension and being aligned in a common nominal direction one with respect to another in said monolayer,
wherein said product has a nominal dimension in said nominal direction, and the longitudinal dimension of a majority of the discrete elongate TVP strands is generally same as said nominal dimension; and
wherein a load of at least 10N or 25N is required for, respectively, 66% or 80% penetration of a 1 mm thick metal plate jig progressed into said food product in a velocity of 50 mm/min, the metal jig being in an orientation that is perpendicular to a nominal direction of elongate strands within the product.

68. The alternative food product of claim 67, wherein upon disintegration of the product, the total weight of the discrete elongate strands is at least 50% out of a total weight of product before disintegration.

69. The alternative food product of claim 67, being an alternative whole muscle cut.

70. The alternative food product of claim 67, being an alternative whole muscle cut.
